(19) United States
(12) Patent Application Publication
(10) Pub. No.: US 2007/0140623 A1
(43) Pub. Date: Jun. 21, 2007

(54) OPTICAL FIBER CONNECTION FITTING

(76) Inventor: Raymond J. Desanti, West Boylston, MA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/539,114

(22) Filed: Oct. 5, 2006

Related U.S. Application Data
(60) Provisional application No. 60/723,877, filed on Oct. 5, 2005.

(51) Int. Cl. G02B 6/36

(52) U.S. Cl. 385/76; 385/139

(57) ABSTRACT

An optical fiber connection sleeve adapted to receive an optical fiber connector at one end and an optical fiber adapter at the other. The sleeve protects the fiber connection that results from the fiber connector joining the fiber adapter within the sleeve. An optical fiber connector parking lot fitting that can be secured to a panel and receive an optical fiber connector. The fiber connector is protectively garaged in the panel-secured fitting pending the connector's use.

### CROSS-REFERENCE TO RELATED APPLICATION

This application claims the benefit of U.S. Provisional Patent Application No. 60/723,877, filed Oct. 5, 2005, expressly incorporated herein by reference in its entirety.

### FIELD OF THE INVENTION

The present invention relates to fittings that are useful in protecting an optical fiber connection.

### BACKGROUND OF THE INVENTION

Optical fiber connections join optical fibers. A fiber connector is joined with a fiber adapter to provide an optical fiber connection. The connector and adapter have a plug and socket relationship.

Problems with an optical fiber connection result if the fiber connector and the fiber adapter are not in optical communication. The optical fiber connection is susceptible to reduced performance or failure when dust, water, or other debris interferes with the connection. The optical connection is also sensitive to a variety of other disturbances than can result in loss of performance. A need exists for devices for improving optical fiber connection that results from the joining of a fiber connector with a fiber adapter. The present invention seeks to fulfill this need and provides further related advantages.

### SUMMARY OF THE INVENTION

In one aspect, the present invention provides an optical fiber connection fitting. The optical fiber connection fitting is a sleeve that is adapted to receive an optical fiber connector at one end and an optical fiber adapter at the other. The connection sleeve protects the optical fiber connection that results from the fiber connector joining the fiber adapter within the connection sleeve.

In another aspect, the invention provides an optical fiber connector parking lot fitting. The parking lot fitting is a boot that is adapted to receive an optical fiber connector. The boot also includes a resilience ridge for securing the fitting to a parking lot panel. Once the fitting is secured to the panel, the optical fiber connector can be protectively garaged in the panel-secured fitting pending the connector's use. The fitting protects the garaged connector from dust, water, and other debris pending the use of the connector.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1A is a perspective view of a representative optical fiber connection sleeve of the present invention;

FIG. 1B is a cross-sectional view of a representative optical fiber connection sleeve of the invention, the cross section taken along the sleeve's length;

FIG. 1C is a cross-sectional view of a representative optical fiber connection sleeve of the invention, the cross section taken along sleeve's width;

FIG. 2 is an illustration of the use of a representative optical fiber connection sleeve of the invention to house an optical fiber connection between a fiber connector and a fiber adapter;

FIG. 3A is a perspective view of a representative optical fiber connector parking lot fitting of the invention;

FIG. 3B is a cross-sectional view of a representative optical fiber connector parking lot fitting, the cross section taken along the fitting's width;

FIG. 3C is a cross-sectional view of a representative optical fiber connector parking lot fitting of the invention, the cross section taken along the fitting's length;

FIG. 4 is a representative parking lot panel; and

FIG. 5 is an illustration of two representative parking lot fittings of the invention secured in a panel for receiving and protectively garaging a fiber connector.

### DETAILED DESCRIPTION OF THE PREFERRED EMBODIMENT

In one aspect, the present invention provides an optical fiber connection sleeve. The sleeve houses the optical fiber connection made by joining an optical fiber connector and an optical fiber adapter. The sleeve protects the optical fiber connection by stabilizing the connection between the fiber connector and the fiber adapter. The sleeve also serves to protect the optical fiber connection from materials and conditions that can interfere with the optical fiber connection. For example, the sleeve protects the optical fiber connection from dust, water, and other debris.

In one embodiment, the optical fiber connection fitting includes a sleeve having a first end and a second end. The first end is adapted to receive an optical fiber connector. The second end is adapted to receive an optical fiber adapter. The sleeve is adapted to house the optical connection formed by joining the optical fiber connector and the optical fiber adaptor.

In one embodiment, the fitting further includes a channel for receiving an optical fiber connector's ridge to orient the fiber connector in the sleeve.

In one embodiment, the fitting further includes a flexible arm extending from the sleeve and terminating with a tab having a slice and an aperture. The aperture is adapted to receive an optical fiber emanating from an optical fiber connector.

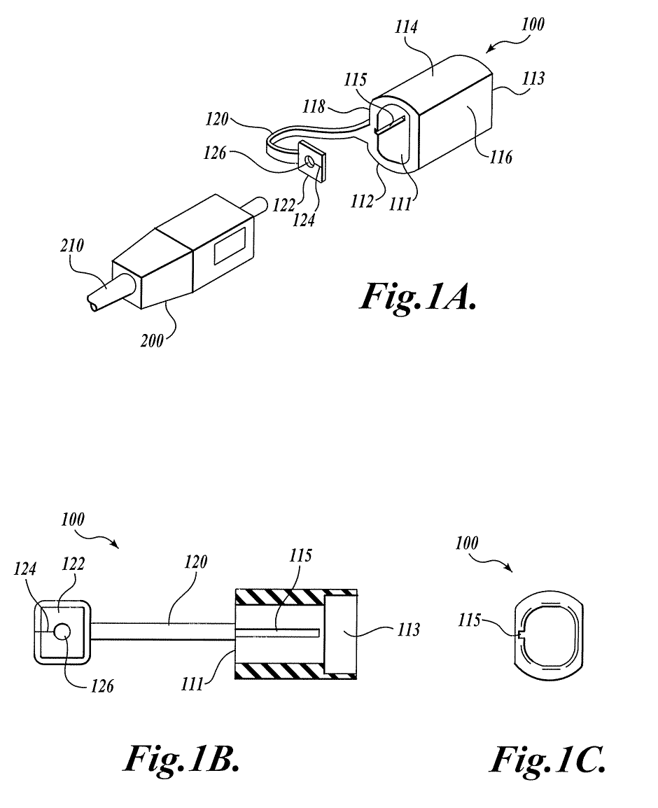

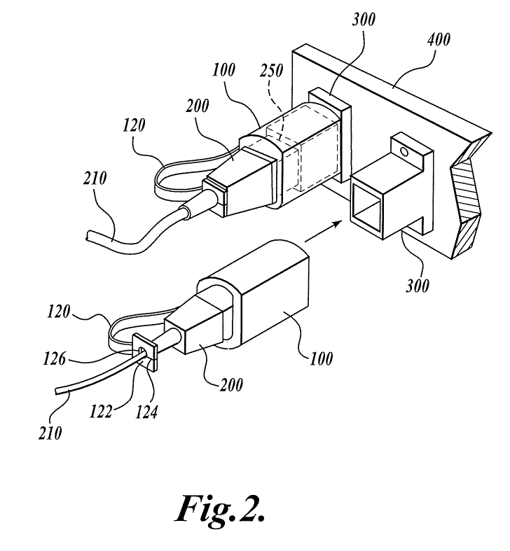

Representative optical fiber connection sleeves of the invention are illustrated in FIGS. 1 and 2.

Referring to FIG. 1A, optical fiber connection sleeve 100 has opposing surfaces 112 and 114, opposing surfaces 116 and 118, and ends 111 and 113 (e.g., apertures) adapted for receiving optical fiber connector 200 and optical fiber adapter 300 (see FIG. 2), respectively. Surfaces 112, 114, 116, and 118 form the sleeve. First end 111 has a shape that is adapted for receiving fiber connector 200 and second end 113 has a shape adapted for receiving fiber adapter 300. In one embodiment, sleeve 100 further includes channel 115 on the interior surface of surface 118 for receiving the fiber connector's ridge (not shown) to orient the fiber connector in the sleeve.

In one embodiment, connection sleeve 100 includes flexible arm 120 extending from the body of the sleeve and terminating with tab 122 that includes slice 124 and aperture 126. Once the fiber connector has been secured in the connection sleeve, flexible arm 120 allows tab 122 to secure and protect optical fiber 210 as it enters fiber connector 200. Slice 124 facilitates positioning of tab 122 over optical fiber 210, which is received by aperture 126. Securing of flexible arm 120 to optical fiber 210 is illustrated in FIG. 2.

FIG. 1B is a cross-sectional view of a representative optical fiber connection sleeve of the invention. In this view, the cross section is along the length of the connection sleeve. Referring to FIG. 1B, connection sleeve 100 includes optional channel 115 for orienting the fiber connector in the sleeve. Flexible arm 120 terminating in tab 122 having slice 124 and aperture 126 are also illustrated. First end 111 and second end 113 for receiving the fiber connector and the fiber adapter, respectively, are also shown.

FIG. 1C illustrates a second cross-sectional view of a representative optical fiber connection sleeve of the invention. In this view, the cross section is along the width of the sleeve. Referring to FIG. 1C, connection sleeve 100 includes optional channel 115.

FIG. 2 illustrates the optical fiber connection made by joining a fiber connector with a fiber adapter through a representative optical fiber connection sleeve of the invention. Referring to FIG. 2, optical fiber connection 250 is made by joining fiber adapter 300 (mounted on surface 400) with the assembly of a representative connection sleeve 100 that has received fiber connector 200. As noted above, the sleeve is adapted to house the optical connection formed by joining the optical fiber connector and the optical fiber adaptor.

The optical fiber connection sleeve of the invention can be made from a variety of materials (e.g., plastics and rubbers). In one embodiment, the connection sleeve is made from molded rubber. The connection sleeve can weatherproof and protect the optical fiber connection from dust, water, and other debris.

In another aspect of the invention, an optical fiber connector parking lot fitting is provided. Like the optical fiber connection sleeve, the parking lot fitting is adapted to receive an optical fiber connector. However, unlike the connection sleeve, the parking lot fitting is a capped sleeve (or boot). The boot has a single opening (e.g., aperture) for receiving the fiber connector on one terminus of the boot. The opposing end of the fitting includes a cap.

The optical fiber connector parking lot fitting includes a boot having an opening adapted to receive an optical fiber connector. In one embodiment, the fitting further includes a channel for receiving an optical fiber connector's ridge to orient the connector in the boot. In one embodiment, the fitting further includes a cap having a resilient ridge adapted for securing the fitting to a panel.

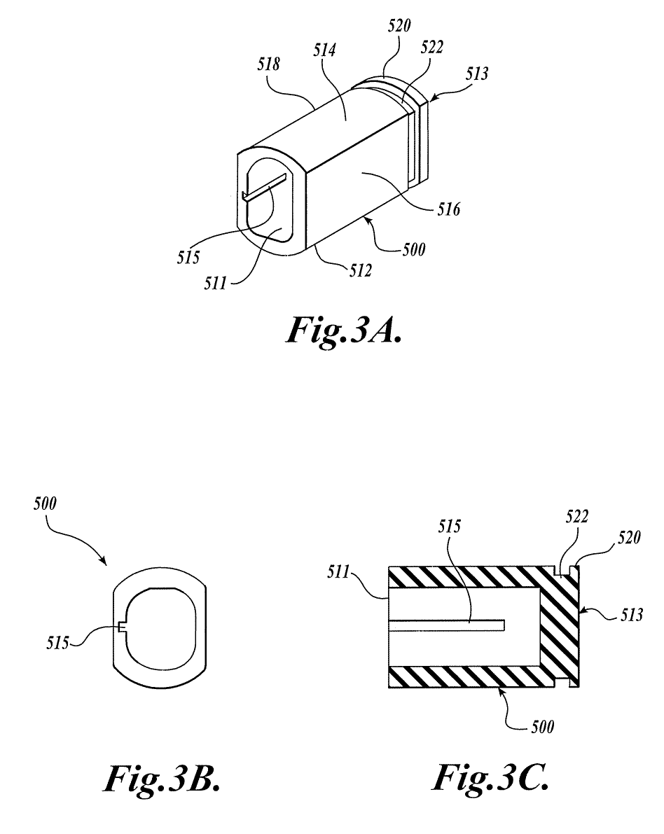

A representative optical fiber connector parking lot fitting (or boot) of the invention is illustrated in FIGS. 3 and 5.

FIG. 3A illustrates a perspective view of a representative parking lot fitting of the invention. Referring to FIG. 3A, boot 500 includes opposing surfaces 516 and 518, opposing surfaces 512 and 514, opening 511 adapted for receiving a fiber connector, optional channel 515 in the interior surface of surface 518 for receiving the fiber connector's ridge (not shown) for orienting the fiber connector in the fitting, and cap 513 for securing the fitting to a panel. Cap 513 includes resilient ridge 520 and cutaway region 522, which facilitate securing the fitting to a panel.

FIG. 3B shows a cross-sectional view of a representative parking lot fitting of the invention. In this view, the cross section is along the width of the fitting. Referring to FIG. 3B, boot 500 includes opposing surfaces 512 and 514, opposing surfaces 516 and 518, and optional channel 515 in the interior surface of surface 518.

FIG. 3C is a cross-sectional view of a representative parking lot fitting of the invention. In this view, the cross section is along the length of the fitting. Referring to FIG. 3C, boot 500 includes opening 511 adapted for receiving a fiber connector that is oriented within the fitting by optional channel 515. Boot 500 includes cap 513 having resilient ridge 520 and cutaway region 522.

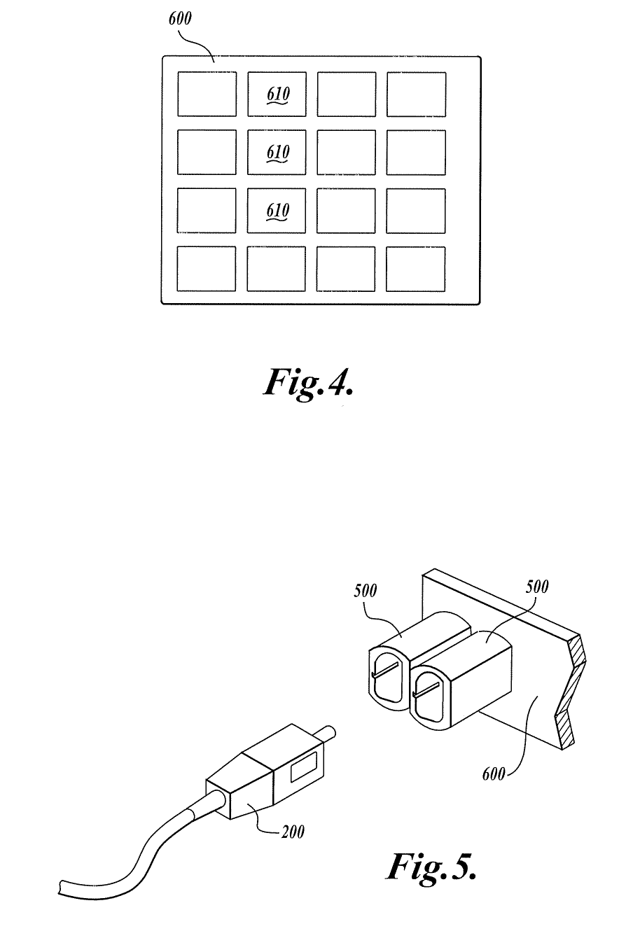

FIG. 4 is an elevation view of a representative parking lot panel that can receive sixteen optical fiber connector parking lot fittings of the invention. Referring to FIG. 4, panel 600 includes sixteen apertures 610 for receiving sixteen boots. Boot 500 is secured in panel 600 by pressing boot 500 against the panel such that resilient ridge 520 passes through aperture 610, the perimeter of which rests in cutaway region 522 thereby securing the fitting in the panel.

FIG. 5 is an illustration of two parking lot fittings of the invention secured in a parking lot panel. Referring to FIG. 5, boots 500 are secured in panel 600 and are ready to receive fiber connector 200.

The optical fiber connector parking lot fitting of the invention can be made from a variety of materials (e.g., plastics and rubbers). In one embodiment, the fitting is made from molded rubber.

The parking lot fitting allows for protective garaging an optical fiber connector pending the connector's use. The fitting protects the optical fiber connection from dust, water, and other debris by housing the fiber connector and its optical fiber terminus in the fitting pending its use.

The devices of the invention are useful in protecting and garaging a variety of optical fiber connectors including, for example, ST, SC, SC/APC, LC, and SC Duplex connectors.

Although representative devices are described and illustrated herein, it will be appreciated that these devices can be adapted for any one of a variety of optical fiber connectors.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. An optical fiber connection fitting, comprising a sleeve having a first end and a second end, wherein the first end is adapted to receive an optical fiber connector, wherein the second end is adapted to receive an optical fiber adapter, and wherein the sleeve is adapted to house the optical connection formed by joining the optical fiber connector and the optical fiber adaptor.

2. The fitting of claim 1, further comprising a channel for receiving an optical fiber connector's ridge to orient the fiber connector in the sleeve.

3. The fitting of claim 1, further comprising a flexible arm extending from the sleeve and terminating with a tab having a slice and an aperture, wherein the aperture is adapted to receive an optical fiber emanating from an optical fiber connector.

4. The fitting of claim 1, wherein the sleeve is molded rubber.

5. An optical fiber connector parking lot fitting, comprising a boot having an opening adapted to receive an optical fiber connector.

6. The fitting of claim 5, further comprising a channel for receiving an optical fiber connector's ridge to orient the connector in the boot.

7. The fitting of claim 5, further comprising a cap having a resilient ridge adapted for securing the fitting to a panel.

8. The fitting of claim 5, wherein the sleeve is molded rubber.
